(19) United States
(12) Patent Application Publication
(10) Pub. No.: US 2026/0077780 A1
(43) Pub. Date: Mar. 19, 2026

(54) VEHICLE AND METHOD OF CONTROLLING THE SAME

(71) Applicants: HYUNDAI MOTOR COMPANY, Seoul (KR); KIA CORPORATION, Seoul (KR)

(72) Inventor: Ik Soon Lim, Hwaseong-si (KR)

(73) Assignees: HYUNDAI MOTOR COMPANY, Seoul (KR); KIA CORPORATION, Seoul (KR)

(21) Appl. No.: 19/098,213

(22) Filed: Apr. 2, 2025

(30) Foreign Application Priority Data
Sep. 13, 2024 (KR) 10-2024-0125799

(51) Int. Cl. B60W 50/14; B60W 30/14; B60W 40/08

(52) U.S. Cl. CPC B60W 50/14; B60W 30/146; B60W 40/08; B60W 2040/089; B60W 2540/106; B60W 2540/21; B60W 2556/10

(57) ABSTRACT

A vehicle and a method of controlling the same are provided. The vehicle according to example embodiments of the present disclosure may include an input/output interface, and a processor, wherein when a speed limit function of the vehicle is activated, the processor determines whether the activation of the speed limit function is an error event, and when it is determined that the activation of the speed limit function is the error event, outputs a notification for deactivating the speed limit function through the input/output interface.

### CROSS-REFERENCE TO RELATED APPLICATION

This application claims priority to and the benefit of Korean Patent Application No. 10-2024-0125799, filed on Sep. 13, 2024, the disclosure of which is incorporated herein by reference in its entirety.

### TECHNICAL FIELD

Various embodiments of this disclosure relate to a vehicle that detects an unintentionally occurring vehicle-related function, and a method of controlling the same.

### BACKGROUND

Recently, as driving assistance technologies and autonomous driving functions have become widespread, a function of maintaining the acceleration of a vehicle at a preset speed (e.g., cruise control), a function of limiting the vehicle to a predetermined speed or lower (e.g., speed limit), and the like are being used in vehicles.

However, as driving assistance functions are becoming increasingly diverse, drivers sometimes have difficulty in manipulating an interface to activate or deactivate (e.g., specific) driving assistance functions and autonomous driving functions.

In an example embodiment, a speed limit function (e.g., speed limit) that has been recently provided is not (e.g., easily) deactivated by inputs that drivers commonly try, such as a brake or accelerator pedal, once activated. In an example embodiment, the activated function is released (e.g., only) when a (e.g., specific) button on a steering wheel or the like is pushed.

When such a speed limit function is activated due to the driver's unintentional behavior in a (e.g., specific) road situation, such as an expressway, the driver may become confused due to the (e.g., unfamiliarly) controlled driving environment.

### SUMMARY

The present disclosure is directed to determining whether the activation of a speed limit function is a driver's unintentional error event when the speed limit function of a vehicle is activated and providing a notification for deactivating the speed limit function when it is determined that the activation is an error event.

Objects of the present disclosure are not limited to the objects described herein, and other objects that are not mentioned may be understood from the description herein.

A vehicle according to various embodiments of the present disclosure may include an input/output interface and a processor, wherein when a speed limit function of the vehicle is activated, the processor determines whether the activation of the speed limit function is an error event, and when it is determined that the activation of the speed limit function is the error event, outputs a notification for deactivating the speed limit function through the input/output interface.

The processor may determine whether the activation of the speed limit function is the error event based on first driving data which is driving data of a driver before the speed limit function is activated and second driving data which is the driving data of the driver after the speed limit function is activated.

The processor may calculate an error score for determining whether the activation of the speed limit function is the error event based on the first driving data and the second driving data and determine that the activation of the speed limit function is the error event when the error score is a predetermined value or more.

The first driving data may include information about the number of times the driver uses the speed limit function of the vehicle for a predetermined period, and the processor may set the information about the number of times the driver uses the speed limit function of the vehicle as a weight when calculating the error score.

The processor may set the weight to be lower as the number of times the driver uses the speed limit function of the vehicle is higher.

The first driving data and the second driving data may include at least one of an acceleration input intensity and an acceleration input holding time of the driver.

The first driving data and the second driving data may include information about the number of times acceleration and deceleration inputs of the driver are alternately input within a predetermined time.

The processor may recognize a voice of the driver and determine whether the activation of the speed limit function is the error event.

The notification for deactivating the speed limit function may include content related to an input unit for deactivating the speed limit function.

The processor may (e.g., automatically) deactivate the speed limit function when the activation of the speed limit function is the error event.

A method of controlling a vehicle according to various example embodiments of the present disclosure may include, when a speed limit function of a vehicle is activated, determining whether the activation of the speed limit function is an error event, and, when it is determined that the activation of the speed limit function is the error event, outputting a notification for deactivating the speed limit function.

The determining of whether the activation of the speed limit function is the error event may include determining whether the activation of the speed limit function is the error event based on first driving data which is driving data of a driver before the speed limit function is activated and second driving data which is the driving data of the driver after the speed limit function is activated.

The determining of whether the activation of the speed limit function is the error event may include calculating an error score for determining whether the activation of the speed limit function is the error event based on the first driving data and the second driving data, and determining that the activation of the speed limit function is the error event when the error score is a predetermined value or more.

The first driving data may include information about the number of times the driver uses the speed limit function of the vehicle for a predetermined period, and the calculating of the error score may include setting the information about the number of times the driver uses the speed limit function of the vehicle as a weight when calculating the error score.

The setting of the information about the number of times the driver uses the speed limit function as the weight when calculating the error score may include setting the weight to be lower as the number of times the driver uses the speed limit function of the vehicle is higher.

The first driving data and the second driving data may include at least one of an acceleration input intensity and an acceleration input holding time of the driver.

The first driving data and the second driving data may include information about the number of times acceleration and deceleration inputs of the driver are alternately input within a predetermined time.

The determining of whether the activation of the speed limit function is the error event may include recognizing a voice of the driver and determining whether the activation of the speed limit function is the error event.

The notification for deactivating the speed limit function may include content related to an input unit for deactivating the speed limit function.

The method may further include (e.g., automatically) deactivating the speed limit function when the activation of the speed limit function is the error event.

### BRIEF DESCRIPTION OF THE DRAWINGS

The above and other objects and features of the present disclosure will become more apparent by describing exemplary embodiments thereof with reference to the accompanying drawings, in which:

FIG. 1 shows a configuration of a vehicle according to an example embodiment;

FIG. 2 is a flowchart of an operation for determining an error event and providing a notification in a control device according to an example embodiment;

FIG. 3 is an exemplary view of a speed limit function button according to an example embodiment;

FIG. 4 is a flowchart of a (e.g., specific) operation for determining an error event and providing a notification in the control device according to an example embodiment;

FIG. 5 is a flowchart of an operation of calculating an error score according to an example embodiment;

FIG. 6 is an exemplary view of content related to first driving data according to an example embodiment;

FIG. 7 is a flowchart of an operation for determining an error event in the control device according to an example embodiment; and

FIG. 8 is a flowchart of an operation for determining an error event and performing automatic control in the control device according to an example embodiment.

### DETAILED DESCRIPTION

Hereinafter, exemplary embodiments according to the present disclosure will be described in detail with reference to the accompanying drawings.

However, the present disclosure is not limited to the described embodiments, but may be implemented in various different forms, and one or more of the components among the embodiments may be used by being (e.g., selectively) coupled or substituted without departing from the present disclosure.

In addition, terms (e.g., including technical and scientific terms) used in embodiments of the present disclosure may be construed having a meaning that may be understood with respect to the present disclosure unless defined and described specifically or otherwise, and the meanings of the commonly used terms, such as terms defined in a dictionary, may be construed in consideration of contextual meanings of related technologies.

In addition, the terms used in the embodiments of the present disclosure are for describing the embodiments and are not intended to limit the present disclosure.

In the disclosure, a singular form may include a plural form unless otherwise specified in the phrase, and when described as “at least one (or one or more) of A, B, and C,” one or more among possible combinations of A, B, and C may be included.

In addition, terms such as first, second, A, B, (a), and (b) may be used to describe components of the embodiments of the present disclosure.

These terms are for the purpose of distinguishing one component from another component, and the nature, sequence, order, or the like of the corresponding components is not limited by these terms.

In addition, when a first component is described as being “connected,” “coupled,” or “joined” to a second component, it may include a case in which the first component is (e.g., directly) connected, coupled, or joined to the second component, but also a case in which the first component is “connected,” “coupled,” or “joined” to the second component by other components present between the first component and the second component.

In addition, when the first component is described as being formed or disposed on “on (above) or below (under)” the second component, “on (above)” or “below (under)” may include a case in which two components are in (e.g., direct) contact with each other and/or a case in which one or more third components are formed or disposed between the two components. In addition, when described as “on (above) or below (under),” it may include the meaning of an upward direction and/or a downward direction based on one component.

In various flowcharts of the present disclosure, at least some of operations may be omitted or their orders may be changed, and at least some of various embodiments of the present disclosure may be performed at a (e.g., specific) time point in each operation of the flowchart. Various flowcharts herein may be performed by at least one of a control device 100, a processor 130, a control unit, or a computer program.

Hereinafter, embodiments will be described in detail with reference to the accompanying drawings, and the same or corresponding components are denoted by the same reference numeral regardless of the reference numerals, and overlapping descriptions thereof may be omitted.

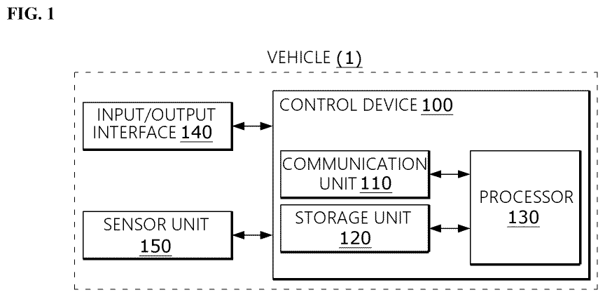

FIG. 1 shows a configuration diagram of a vehicle 1 according to an example embodiment.

The vehicle 1 may include the control device 100, a communication unit 110, a storage unit 120, a processor 130, an input/output interface 140, and a sensor unit 150. Each component of FIG. 1 may be implemented inside the vehicle.

The control device 100 is a device or program for determining whether a speed limit function of the vehicle 1 is a driver's unintentional error event when the speed limit function of the vehicle 1 is activated and controls a notification of the vehicle 1 according to the result of the determination. The control device 100 may be formed (e.g., integrally) with internal components of the vehicle and implemented as a (e.g., separate) device and connected to the internal components of the vehicle by a (e.g., separate) connection unit. The control device 100 is shown as including the communication unit 110, the storage unit 120, and the processor 130, but may be formed in a manner that includes another component (e.g., the input/output interface 140) of the vehicle 1.

The communication unit 110 may communicate with a user terminal, another vehicle, or an external server. The communication unit 110 may perform functions of short range communication, GPS signal reception, vehicle to everything (V2X) communication, optical communication, broadcast transmission/reception, and/or intelligent transport systems (ITS) communication functions. The communication unit 110 may support short range communication using at least one of Bluetooth, radio frequency identification (RFID), infrared data association (IrDA), ultra-wideband (UWB), ZigBee, near field communication (NFC). Wi-Fi, Wi-Fi Direct, and/or wireless universal serial bus (USB) technologies. The communication unit 110 may include a mobile communication module using a mobile communication network, and a wireless Internet module for wireless Internet access.

The storage unit 120 may include instructions related to logic for determining whether an event in which a speed limit function is activated is an error event. In addition, the storage unit 120 may include driving data of the driver. The storage unit 120 may include a memory. The storage unit 120 may be provided inside the processor 130 or the control device 100, or may be a (e.g., separate) memory. The storage unit 120 may be formed in a combination of a non-volatile memory, such as a hard disk drive, a flash memory, an electrically erasable programmable read-only memory (EEPROM), a static RAM (SRAM), a ferro-electric RAM (FRAM), a phase-change RAM (PRAM), and a magnetic RAM (MRAM) and/or a volatile memory, such as a DRAM, a synchronous DRAM (SDRAM), and a double data rate-SDRAM (DDR-SDRAM).

The processor 130 may be electrically or operatively connected to the communication unit 110, the storage unit 120, the input/output interface 140, the sensor unit 150, and various internal components of the vehicle 1 and may be an electrical circuit for electrically controlling each component and executing software commands, thereby performing various data processing and calculations, described herein.

The processor 130 may process signals transmitted between components of the vehicle 1 and perform overall control so that each component may (e.g., normally) perform its function. The processor 130 may be implemented in the form of hardware, implemented in the form of software, or implemented in the form of a combination of hardware and software. In addition, the control device 100 may include at least one processor 130.

The input/output interface 140 may include an input unit for receiving a control command from a user and an output unit for outputting an operation state, results, and the like of the control device 100. Here, the input unit may include a physical key (e.g., a physical button) and a soft key implemented on a touch display.

The output unit may include a display and further include a voice output unit such as a speaker, and a haptic module that generates vibrations. In an example embodiment, when a touch sensor such as a touch film, a touch sheet, or a touch pad is provided on the display, the display operates as a touch screen, and the input unit and the output unit may be implemented in an integrated form.

The input/output interface 140 may be implemented as a physical button, a display, a head-up display (HUD), a cluster, an audio video navigation (AVN), a human machine interface (HMI), a user setting menu (USM), or the like. In addition, the display may be included in a rearview mirror or a side mirror.

For example, a user may request operations (e.g., via a display) related to the evaluation of a driver's attention state and the control of autonomous driving-related functions through the physical button of the cluster as an input unit or a display of the AVN. In addition, the vehicle 1 may receive an input or output from a screen through a display of a console positioned in a second or third row of the vehicle or a display of an application implemented in a user terminal.

The sensor unit 150 may include at least one of radio detection and ranging (radar), light detection and ranging (LiDAR), a fingerprint recognition sensor, a retina recognition sensor, an iris recognition sensor, a camera, a steering wheel grip sensor, a pressure sensor, a position sensor (e.g., GPS), an ultrasonic sensor, a heart rate sensor, an optical sensor, a pressure sensor, a motion sensor, a seating sensor, or an infrared sensor. The camera may include an external camera for monitoring the outside of the vehicle and an internal camera for detecting an object, such as a driver, inside the vehicle.

The sensor unit 150 may include a sensor (e.g., a pressure sensor) for measuring pressures of an accelerator pedal and a brake pedal to detect acceleration and deceleration inputs of the driver. In addition, the sensor unit 150 may include a timer function module for measuring a duration for which the pedal is pressed.

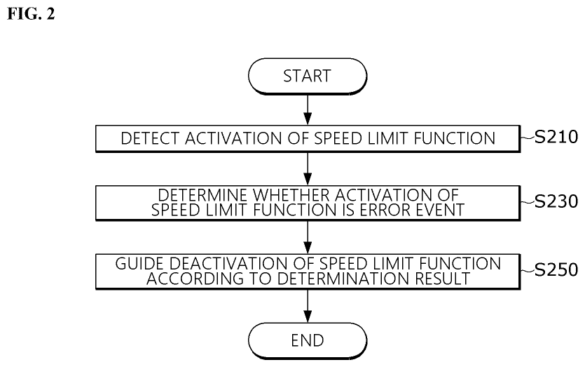

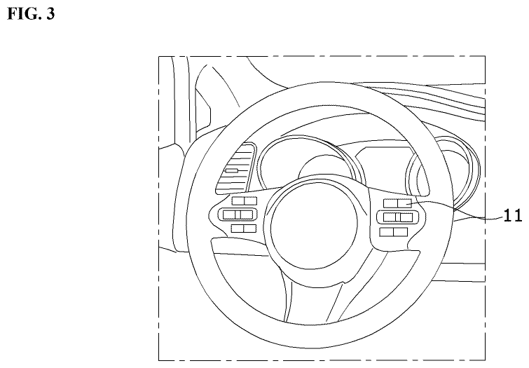

FIG. 2 is a flowchart of an operation for determining an error event and providing a notification in a control device according to an example embodiment. FIG. 3 is an exemplary view of a mode change button according to an example embodiment.

The control device 100 may detect whether the speed limit function of the vehicle 1 is activated (S210).

For example, the processor 130 may detect an input of a user pushing a mode change button 11 in FIG. 3. The mode change button 11 may be an input unit for activating or deactivating the speed limit function. The input/output interface 140 may include the mode change button 11. Meanwhile, the mode change button 11 may be implemented as a soft key (e.g., a touch item) that may be displayed through a display as well as a physical key.

Through the mode change button 11, another driving assistance or autonomous driving function of the vehicle 1 may be selected. Therefore, when the user presses the mode change button 11, a driving assistance function, such as cruise control, in addition to the speed limit function according to the embodiment of the present disclosure may be activated.

Even when the cruise control function is activated by the mode change button 11, acceleration by the accelerator pedal is possible, and since the cruise control function is (e.g., automatically) deactivated when the brake pedal is input, there is no interference (e.g., problem) even when the cruise control function is unintentionally activated.

However, once activated, the speed limit function such as the speed limit may not be deactivated by other inputs and may be deactivated by (e.g., only) the mode change button 11. Therefore, it is useful to check whether the activation of the speed limit function by the mode change button 11 is a driver's intentional event.

The control device 100 may determine whether the activation of the speed limit function is an error event (S230).

In an example embodiment, the processor 130 may detect whether a driver's abnormal behavior occurs when the speed limit function is activated. The driver's abnormal behavior may provide (e.g., mean), for example, that the driver's behavior is hindered by the unintentional activation of the speed limit function. For example, even though the speed limit function has been started, a behavior, such as (e.g., continuously) strongly pressing the accelerator pedal to drive faster than a current speed limit or alternately pressing the brake pedal and the accelerator pedal, may be detected.

According to an example embodiment, the control device 100 may determine whether the activation of the speed limit function is an error event based on a driver's cumulative driving data before the speed limit function is activated and driving data after the speed limit function is activated. Description thereof is provided herein.

The control device 100 may provide a guide notification for deactivating the speed limit function based on the result of the determination (S250).

According to an example embodiment, when it is determined that the activation of the speed limit function is an error event, the processor 130 may include content about an input unit capable of deactivating the speed limit function in the notification and provide the (e.g., above) notification through the input/output interface 140.

For example, the processor 130 may generate and display a steering wheel including the mode change button 11 as a UI content as shown in FIG. 3. The content may be displayed through the display (e.g., a cluster, a head on display (HUD), or an AVN display) of the vehicle 1. In an example embodiment, in order for the driver to (e.g., easily) recognize the mode change button 11, the mode change button 11 may be displayed as content to be distinguished from other areas in the UI content of the steering wheel. In addition, an indicator indicating the mode change button 11 may be further displayed. In addition, at least one of a text message and a voice message that instructs the driver to release the speed limit function by pressing the mode change button 11 may be further output through the input/output interface 140.

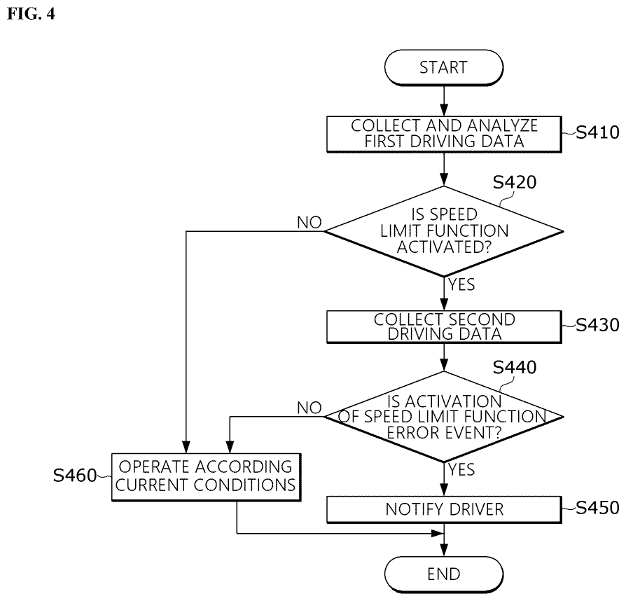

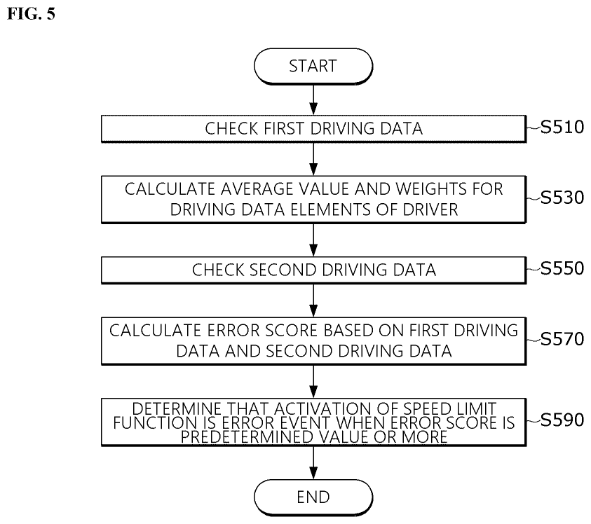

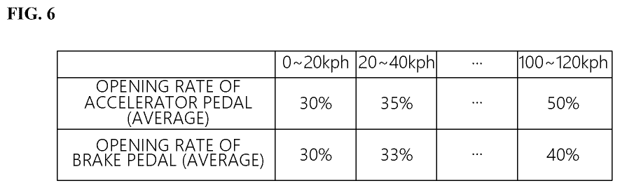

FIG. 4 is a flowchart of a (e.g., specific) operation for determining an error event and providing a notification in the control device 100 according to an example embodiment, and FIG. 5 is a flowchart of an operation of calculating an error score according to an example embodiment. FIG. 6 is an exemplary view of first driving data according to an example embodiment. Among contents of FIG. 4, overlapping contents of FIG. 3 may be omitted. In addition, among contents of FIG. 5, overlapping contents of FIGS. 3 and 4 may be omitted.

The control device 100 may collect and analyze the first driving data (S410).

According to an example embodiment, the first driving data may be driving data of the driver before the speed limit function is activated. The first driving data may include driving data of the driver accumulated for a predetermined period, and the first driving data may be stored in the storage unit 120 and updated according to driving. The first driving data may be used to determine and learn a driver's usual driving habit.

According to an example embodiment, the first driving data may include information about the number of times the driver has used the speed limit function of the vehicle 1 for a predetermined period. The number of times the driver has used the speed limit function may be, for example, information representing how often the driver has used the speed limit function in the past as the number of times. Therefore, it is possible to check whether the corresponding driver is a user who may (e.g., effectively) use the speed limit function.

According to an example embodiment, the information about the number of times the driver has used the speed limit function may be set as a weight in the process of calculating an error score to determine an error event.

According to an example embodiment, the first driving data may include at least one of a driver's acceleration input intensity and a duration of an acceleration input for a predetermined period. The acceleration input may be identified, for example, through information about an opening rate of the accelerator pedal, and the deceleration input may be identified, for example, through information about an opening rate of the brake pedal.

According to an example embodiment, the first driving data may include information about the number of times that the acceleration and deceleration inputs of the driver are alternately input within a predetermined period.

Next, the control device 100 may determine whether the speed limit function has been activated (S420). When the speed limit function is not activated (No in S420), the control device 100 may control the vehicle 1 according to current conditions (S460). For example, when the driver (e.g., directly) controls driving, the processor 130 may control the driving of the vehicle 1 according to the driver's control input.

When the speed limit function is activated (Yes in S420), the control device 100 may collect second driving data (S430).

According to an example embodiment, the second driving data may be driving data of the driver after the speed limit function is activated. The second driving data may be stored in the storage unit 120, and the second driving data may be used to determine an error event together with the first driving data.

According to an example embodiment, the second driving data may include at least one of the driver's acceleration input intensity and the duration of the acceleration input after the speed limit function is activated. The acceleration input may be identified, for example, through information about an opening rate of the accelerator pedal, and the deceleration input may be identified, for example, through information about an opening rate of the brake pedal.

According to an example embodiment, the second driving data may include information about the number of times that the acceleration and deceleration inputs of the driver are alternately input within a predetermined period after the speed limit function is activated.

Next, the control device 100 may determine whether the activation of the speed limit function is an error event (S440).

According to an example embodiment, the processor 130 may determine whether the event in which the speed limit function is activated is an error event based on at least one of the first driving data and the second driving data.

In an example embodiment, the processor 130 may calculate an error score based on the first driving data and the second driving data. When the calculated error score is a predetermined value or more, the processor 130 may determine that the activation event of the speed limit function is the error event.

When the calculated error score is smaller than the predetermined value, it is determined that the activation event of the speed limit function is a normal event, and the processor 130 may control the operation of the vehicle 1 according to the current conditions (S460). For example, when the calculated error score is smaller than the predetermined value, the speed limit function is a driver's intentional event, and thus the processor 130 may maintain the speed of the vehicle 1 at a predetermined speed or lower according to the corresponding speed limit function.

When it is determined that the activation event of the speed limit function is the error event because the error score is the predetermined value or more, the control device 100 may provide the driver notification (S450) described herein.

A process of calculating the error score is disclosed with reference to FIG. 5.

The control device 100 may check the first driving data stored in the storage unit 120 (S510) and derive an average value and weights of driving data elements of the driver (S530).

For example, the processor 130 may identify the driver and check the first driving data stored for the corresponding driver. According to the driver's identification, checking the first driving data of the corresponding driver may be performed by a user selection input or (e.g., automatically) performed through driver identity authentication or the like. For example, a (e.g., specific) user and the first driving data according to the (e.g., specific) user may be identified through fingerprint recognition, a user terminal, or the like.

In addition, the processor 130 may calculate the average value and weight of the driving data elements stored in the first driving data.

For example, the processor 130 may calculate at least one of an average value of the number of times the corresponding driver uses the speed limit function during a predetermined period before the activation event of the speed limit function occurs, an average value of the driver's acceleration input intensities stored during the predetermined period before the activation event of the speed limit function occurs, and an average value of an acceleration input holding time stored during the predetermined period before the activation event of the speed limit function occurs.

For example, referring to FIG. 6, as the first driving data, the average value of the acceleration input intensities calculated for each speed section of the vehicle 1 is shown. The acceleration input intensity may be determined according to the opening rates of the accelerator pedal and the brake pedal, and the average value may be calculated for each speed section of the vehicle 1.

Meanwhile, the processor 130 may set the number of times the driver uses the speed limit function during the predetermined period before the activation event of the speed limit function occurs as a weight.

For example, when the number of times the driver uses the speed limit function is high, that is, when the user is familiar with the speed limit function, a low weight may be set. Conversely, when the number of times the driver uses the speed limit function is low, that is, when the user is not familiar with the speed limit function, a higher weight may be set. The number of times the driver uses the speed limit function may be set based on a (e.g., specific) value and set by comparing (e.g., relative) values for each user.

Meanwhile, the calculated average value and the set weight may be re-stored as the first driving data.

Next, the control device 100 may check the second driving data (S550).

For example, the processor 130 may check the second driving data which is the driving data stored for the corresponding driver after the speed limit function is activated. The processor 130 may (e.g., separately) store previous driving data and subsequent driving data based on the event in which the speed limit function is activated.

Next, the control device 100 may calculate an error score based on the first driving data and the second driving data (S570). The error score may be a value calculated to determine whether the (e.g., specific) event is an error event.

According to an example embodiment, the processor 130 may calculate an error score when the opening rate of the accelerator pedal of the second driving data exceeds an average value of the opening rates of the first driving data corresponding to a current vehicle speed section (herein, “a first condition is satisfied”). That is, the control device 100 may calculate an error score when an input to increase a speed compared to a usual vehicle speed is detected after the speed limit function is activated.

In contrast, the control device 100 may not calculate an error score when the opening rate of the accelerator pedal of the second driving data is the average value or less of the opening rates of the first driving data corresponding to the current vehicle speed section (e.g., the first condition is not satisfied).

According to an example embodiment, the processor 130 may calculate an error score when an acceleration input holding time of the second driving data lasts a predetermined time (e.g., 5 seconds) or more (herein referred to as “a second condition is satisfied”) in a state in which the first condition is satisfied.

In contrast, when the acceleration input holding time of the second driving data lasts less than the predetermined time (e.g., 5 seconds) (e.g., the second condition is not satisfied), the error score may not be calculated.

According to an example embodiment, when both the first condition and the second condition are satisfied, the processor 130 may calculate an error score.

As an example embodiment, the processor 130 may calculate an error score based on the weight set in the first driving data and the acceleration input holding time confirmed in the second driving data. As an example of calculating an error score, Equation 1 is:

$$error score = weight * acceleration input holding time ( s ) \qquad [ Equation 1 ]$$

For example, if a user with a weight of 3 based on the first driving data presses the accelerator pedal for 7 seconds, the error score may be 21.

According to an example embodiment, the control device 100 may calculate an error score based on an average value of the number of times the acceleration input and the deceleration input are alternately input calculated from the first driving data and the number of times the acceleration input and the deceleration input are alternately input confirmed from the second driving data. In an example embodiment, the weight based on the first driving data may be reflected when calculating the error score. As an example of calculating an error score, Equation 2 is:

$$error score = weight * ( current frequency ( Hz ) - average frequency ( Hz ) ) \qquad [ Equation 2 ]$$

The average frequency is a frequency of the average value of the number of the acceleration input(s) and the deceleration input(s) that are alternately input, calculated from the first driving data, and the current frequency may be (e.g., set to) a frequency of the number of the acceleration input(s) and the deceleration input(s) detected from a time point when the speed limit function is activated to a time point when the error score is calculated. In an example embodiment, an average frequency may be normalized to 1, and the current frequency may be a frequency of a (e.g., relative) size comparing the average frequency. Frequency information may be calculated based on an average time interval when the accelerator pedal and the brake pedal are alternately pressed.

The control device 100 may determine that the activation of the speed limit function is an error event when the calculated error score is a predetermined value or more (S590). This predetermined value may be preset or changed. For example, when the predetermined value is set to 20, the value calculated by Equation 1 is 21, and thus in an example embodiment, the control device 100 may determine that the activation event of the speed limit function is an error event.

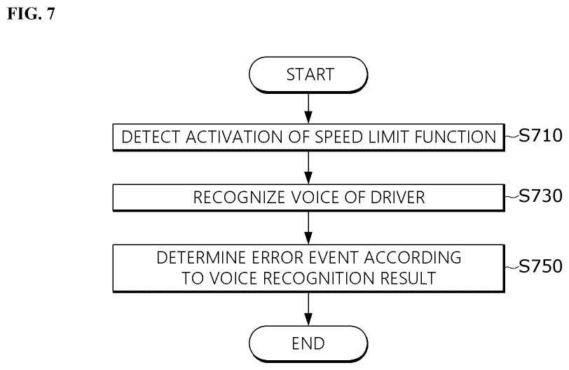

FIG. 7 is a flowchart of an operation for determining an error event in the control device according to an example embodiment. Among contents of FIG. 7, overlapping contents of the drawings described herein may be omitted.

When detecting the activation of the speed limit function (S710), the control device 100 may recognize a voice of the driver (S730). The processor 130 may recognize the voice of the driver through a microphone included in the input/output interface 140.

The control device 100 may determine an error event based on the result of the voice recognition (S750). For example, when detecting the activation of the speed limit function and then recognizing an abnormal voice of the driver for the activation of the speed limit function, the processor 130 may determine that the corresponding event is an error event. The abnormal voice may include, for example, preset words or volumes that are not intended for the speed limit function, but is not limited thereto.

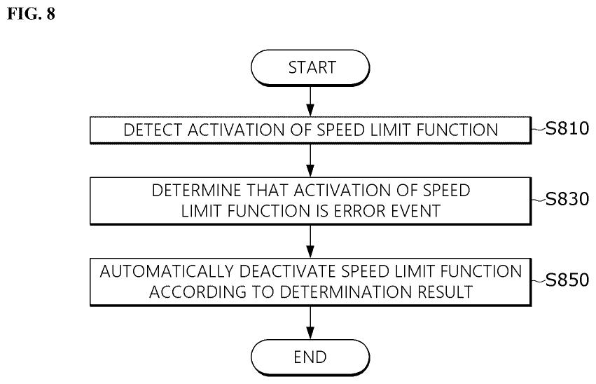

FIG. 8 is a flowchart of an operation for determining an error event and performing automatic control in the control device according to an example embodiment.

When detecting the activation of the speed limit function (S810), the control device 100 may determine whether the activation of the speed limit function is an error event according to the embodiments herein (S830). When it is determined that the activation of the speed limit function is an error event, the control device 100 may (e.g., automatically) release the speed limit function without a (e.g., separate) notification or with a notification (S850).

The term “˜unit” used herein may provide that (e.g., means) a software or hardware component such as a field-programmable gate array (FPGA) or an ASIC, and the “˜unit” performs certain roles. However, the “unit” is not limited to software or hardware. The “unit” may be disposed in an addressable storage medium and configured to reproduce one or more processors. Therefore, as an example embodiment, the “unit” is components such as software components, object-oriented software components, class components, and task components, processes, functions, attributes, procedures, subroutines, segments of program code, drivers, firmware, microcode, circuits, data, database, data structures, tables, arrays, and/or variables. Functions provided in the components and “˜units” may be combined into the smaller number of components and “unit” or separated into additional components and “units.” Additionally, the components and “˜units” may be implemented to reproduce one or more CPUs in a device or a security multimedia card.

According to the present disclosure, when an activated speed limit function is detected as a driver's unintentional error event, it is possible to provide an environment in which the driver can (e.g., more easily) release the speed limit function.

The present disclosure is not limited to the effects described herein, and other effects may be understood from the description herein.

Although the present disclosure has been described herein with reference to exemplary embodiments, the present disclosure may be modified and changed (e.g., variously) without departing from the present disclosure as described in at least the appended claims.

What is claimed is:

1. A vehicle comprising:
an input/output interface; and
a processor,
wherein when a speed limit function of the vehicle is activated, the processor determines whether the activation of the speed limit function is an error event, and when it is determined that the activation of the speed limit function is the error event, outputs a notification for deactivating the speed limit function through the input/output interface.

2. The vehicle of claim 1, wherein the processor determines whether the activation of the speed limit function is the error event based on first driving data which is driving data of a driver before the speed limit function is activated and second driving data which is the driving data of the driver after the speed limit function is activated.

3. The vehicle of claim 2, wherein the processor calculates an error score for determining whether the activation of the speed limit function is the error event based on the first driving data and the second driving data and determines that the activation of the speed limit function is the error event when the error score is a predetermined value or more.

4. The vehicle of claim 3, wherein the first driving data includes information about a number of times the driver uses the speed limit function of the vehicle for a predetermined period, and
the processor sets the information about the number of times the driver uses the speed limit function of the vehicle as a weight when calculating the error score.

5. The vehicle of claim 4, wherein the processor sets the weight to be lower as the number of times the driver uses the speed limit function of the vehicle is higher.

6. The vehicle of claim 4, wherein the first driving data and the second driving data include at least one of an acceleration input intensity and an acceleration input holding time of the driver.

7. The vehicle of claim 4, wherein the first driving data and the second driving data include information about the number of times an acceleration input and a deceleration input are alternately input within a predetermined time.

8. The vehicle of claim 1, wherein the processor recognizes a voice of a driver and determines whether the activation of the speed limit function is the error event.

9. The vehicle of claim 1, wherein the notification for deactivating the speed limit function includes content related to an input unit for deactivating the speed limit function.

10. The vehicle of claim 1, wherein the processor automatically deactivates the speed limit function when the activation of the speed limit function is the error event.

11. A method of controlling a vehicle, comprising:
when a speed limit function of a vehicle is activated, determining whether the activation of the speed limit function is an error event; and
when it is determined that the activation of the speed limit function is the error event, outputting a notification for deactivating the speed limit function.

12. The method of claim 11, wherein the determining of whether the activation of the speed limit function is the error event includes determining whether the activation of the speed limit function is the error event based on first driving data which is driving data of a driver before the speed limit function is activated and second driving data which is the driving data of the driver after the speed limit function is activated.

13. The method of claim 12, wherein the determining of whether the activation of the speed limit function is the error event includes:
calculating an error score for determining whether the activation of the speed limit function is the error event based on the first driving data and the second driving data; and
determining that the activation of the speed limit function is the error event when the error score is a predetermined value or more.

14. The method of claim 13, wherein the first driving data includes information about a number of times the driver uses the speed limit function of the vehicle for a predetermined period, and
the calculating of the error score includes setting the information about the number of times the driver uses the speed limit function of the vehicle as a weight when calculating the error score.

15. The method of claim 14, wherein the setting of the information about the number of times the driver uses the speed limit function as the weight when calculating the error score includes setting the weight to be lower as the number of times the driver uses the speed limit function of the vehicle is higher.

16. The method of claim 14, wherein the first driving data and the second driving data include at least one of an acceleration input intensity and an acceleration input holding time of the driver.

17. The method of claim 14, wherein the first driving data and the second driving data include information about the number of times an acceleration input and a deceleration input are alternately input within a predetermined time.

18. The method of claim 11, wherein the determining of whether the activation of the speed limit function is the error event includes recognizing a voice of a driver and determining whether the activation of the speed limit function is the error event.

19. The method of claim 11, wherein the notification for deactivating the speed limit function includes content related to an input unit for deactivating the speed limit function.

20. The method of claim 11, further comprising automatically deactivating the speed limit function when the activation of the speed limit function is the error event.
